(19) United States
(12) Patent Application Publication
(10) Pub. No.: US 2014/0222169 A1
(43) Pub. Date: Aug. 7, 2014

(54) APPARATUS ADMINISTRATION SYSTEM, DISPLAY DEVICE, AND PROGRAM

(71) Applicants: Hiroki Kazuno, Osaka (JP); Toru Shimotsuma, Osaka (JP); Yoshifumi Murakami, Osaka (JP); Toshiaki Nakao, Osaka (JP); Tomoya Sogo, Osaka (JP)

(72) Inventors: Hiroki Kazuno, Osaka (JP); Toru Shimotsuma, Osaka (JP); Yoshifumi Murakami, Osaka (JP); Toshiaki Nakao, Osaka (JP); Tomoya Sogo, Osaka (JP)

(73) Assignee: PANASONIC CORPORATION, Osaka (JP)

(21) Appl. No.: 14/117,298

(22) PCT Filed: May 16, 2012
(86) PCT No.: PCT/JP2012/062462

§ 371 Date: Nov. 12, 2013

(30) Foreign Application Priority Data
May 24, 2011 (JP) 2011-115952

(51) Int. Cl. G05B 15/02

(52) U.S. Cl. CPC G05B 15/02
USPC 700/17

(57) ABSTRACT

Apparatus administration system includes control device that controls operation of apparatuses and display device communicable with the control device. In the control device, control unit controls each apparatus in accordance with operation schedule stored in schedule storage unit. Operation history storage unit stores operation history in which past operation states are associated with operated dates and times. In the display device, information acquisition unit acquires the operation schedule and the operation history from the control device. Date and time setting unit specifies past date and time to set as set date and time. Estimation unit estimates operation state at the set date and time through the operation schedule. Extraction unit extracts actual operation state at the set date and time from the operation history. Display unit displays the operation state under schedule control and the actual operation state adjacently.

### TECHNICAL FIELD

This invention relates to an apparatus administration system that manages a plurality of apparatuses, a display device that is communicable with a control device configured to control a plurality of apparatuses, and a program used by a computer that is communicable with the control device configured to control a plurality of apparatuses.

### BACKGROUND ART

In recent years, social demand for energy savings has been increasing due to increase in global warming. For example, the Energy Conservation Act in Japan requires that the private sector not only improve the performance of individual apparatuses, but also achieve energy savings from a management perspective such as by using a BEMS (Building Energy Management System). As an energy-saving method from a management perspective, improving an operation schedule that associates control contents of an apparatus with control dates and times is known.

JP 2003-303228A (hereinafter referred to as Patent Document 1) discloses a facility apparatus management system that controls and monitors a plurality of facility apparatuses. The facility apparatus management system described in Patent Document 1 includes: a station that controls and monitors each of the facility apparatuses; and an information terminal that is connected to the station. With the facility apparatus management system described in Patent Document 1, the station notifies the monitoring/control result of each of the facility apparatuses to the information terminal, and the information terminal displays the monitoring/control result of each of the facility apparatuses. Moreover, the information terminal described in Patent Document 1 has a function for displaying an operation schedule of each of the facility apparatuses.

However, with the conventional information terminal described in Patent Document 1, although it can display individually a screen regarding the monitoring/control result of facility apparatuses and a screen regarding the operation schedule of each of the facility apparatuses, it cannot display these screens simultaneously. Therefore, there is a problem in that it is difficult for a user to grasp a difference between: an actual operation state; and an operation state in accordance with the operation schedule (hereinafter, referred to as “schedule control”) for each facility apparatus at a certain past date and time, and accordingly which causes the user to require a lot of time for performing an energy-saving analysis. Here, the energy-saving analysis may include: a work to determine whether an apparatus is turned on unnecessarily; a work to clarify a reason why there is a difference between an actual energy-saving effect and an assumed energy-saving effect; and the like, based on a comparison between the operation state under schedule control and the actual operation state.

### SUMMARY OF INVENTION

The present invention has been made in view of the above-described problems, and an object of the present invention is to provide an apparatus administration system, a display device, and a program that enable a user to easily grasp the difference between operation states under schedule control in accordance with an operation schedule and actual operation states at an arbitrary past date and time.

An apparatus administration system of a 1st configuration according to the present invention is an apparatus administration system for managing a plurality of apparatuses. The apparatus administration system includes a control device configured to control operation of each of the plurality of apparatuses by communication and a display device configured to communicate with the control device. The control device includes: a schedule storage unit configured to store an operation schedule in which control contents are associated with control dates and times for each of the plurality of apparatuses; a control unit configured to control the plurality of apparatuses in accordance with the operation schedule and manipulation related to operation change; and an operation history storage unit configured to store an operation history in which past operation states are associated with operated dates and times for each of the plurality of apparatuses. The display device includes: an information acquisition unit configured to acquire the operation schedule and the operation history from the control device; a date and time setting unit configured to specify a past date and time to set it as a set date and time; an estimation unit configured to estimate an operation state under schedule control at the set date and time from the operation schedule, for each of the plurality of apparatuses; an extraction unit configured to extract from the operation history an actual operation state at the set date and time, for each of the plurality of apparatuses; and a display unit configured to display the operation state under schedule control and the actual operation state in an adjacent manner, for each of the plurality of apparatuses.

With an apparatus administration system of a 2nd configuration according to the present invention, the display device is a portable mobile terminal, and the plurality of apparatuses are located in a predetermined area, in the apparatus administration system according to the 1st configuration.

With an apparatus administration system of a 3rd configuration according to the present invention, the display unit is configured to display the operation state under schedule control and the actual operation state in an adjacent manner in a form of an icon, for each of the plurality of apparatuses, in the apparatus administration system according to the 2nd configuration.

With an apparatus administration system of a 4th configuration according to the present invention, the display unit is configured to display, for each of the plurality of apparatuses, the icon in a superimposed manner on a map on which a location of the apparatus is indicated, in the apparatus administration system according to the 3rd configuration.

With an apparatus administration system of a 5th configuration according to the present invention, the display unit is configured, in a case where the schedule control includes a delay time, to display information about elapsed time regarding the delay time together with the operation state under schedule control, in the apparatus control system according to any of the 1st to 4th configurations.

With an apparatus administration system of a 6th configuration according to the present invention, the display unit is configured to display a timeline chart on which at least one set of dates and times regarding the control date and time or the operated date and time is shown, and the date and time setting unit is configured to set the set date and time based on a date and time designated through the timeline chart, in the apparatus control system according to any of the 1st to 5th configurations.

With an apparatus administration system of a 7th configuration according to the present invention, the date and time setting unit is configured to specify a date and time to be set as the set date and time with using at least one set of dates and times regarding the control date and time or the operated date and time as an index, in the apparatus administration system according to any of the 1st to 5th configurations.

With an apparatus administration system of an 8th configuration according to the present invention, the display device includes a step time setting unit configured to determine a step time to be added to or subtracted from the set date and time, and the date and time setting unit is configured to set, a date and time obtained by adding to or subtracting from the set date and time the step time determined by the step time setting unit, as a new set date and time, in the apparatus administration system according to any of the 1st to 5th configurations.

With an apparatus administration system of a 9th configuration according to the present invention, the step time setting unit is configured: to shorten the step time with respect to a period which includes a large number of control dates and times; and to elongate the step time with respect to a period which includes a small number of control dates and times, in the apparatus administration system according to the 8th configuration.

With an apparatus administration system of a 10th configuration according to the present invention, the display device includes an operation unit configured to enable to set a length of the step time through a touch panel, and the step time setting unit is configured to determine the length of the step time in response to manipulation onto the operation unit, in the apparatus administration system according to the 8th configuration.

With an apparatus administration system of a 11th configuration according to the present invention, the apparatus administration system further includes a sensor device configured to measure an environmental condition in the area, and the display unit is configured to change a visual effect of the map depending on the environmental condition measured through the sensor device, in the apparatus administration system according to the 4th configuration.

A display device according to the present invention is a display device capable of communicating with a control device that controls operation of a plurality of apparatuses by communication in accordance with an operation schedule in which control contents are associated with control dates and times and manipulation related to operation change, and also that stores an operation history in which past operation states are associated with operated dates and times for each of the plurality of apparatuses. The display device includes: an information acquisition unit configured to acquire the operation schedule and the operation history from the control device; a date and time setting unit configured to specify a past date and time to set it as a set date and time; an estimation unit configured to estimate an operation state under schedule control at the set date and time from the operation schedule for each of the plurality of apparatuses; an extraction unit configured to extract from the operation history an actual operation state at the set date and time for each of the plurality of apparatuses; and a display unit configured to display the operation state under schedule control and the actual operation state in an adjacent manner for each of the plurality of apparatuses.

In other words, the display device according to the invention is a display device adapted for use in the apparatus administration system according to any of the 1st to 11th configurations, and includes the information acquisition unit, the date and time setting unit, the estimation unit, the extraction unit, and the display unit.

A program according to the present invention is a program for causing a computer capable of communicating with a control device, where the control device controls operation of a plurality of apparatuses by communication in accordance with an operation schedule in which control contents are associated with control dates and times and manipulation related to operation change and also stores an operation history in which past operation states are associated with operated dates and times for each of the plurality of apparatuses, to function as: an information acquisition unit configured to acquire the operation schedule and the operation history from the control device; a date and time setting unit configured to specify a past date and time to set as a set date and time; an estimation unit configured to estimate an operation state under schedule control at the set date and time from the operation schedule for each of the plurality of apparatuses; an extraction unit configured to extract from the operation history an actual operation state at the set date and time for each of the plurality of apparatuses; and a display unit configured to display the operation state under schedule control and the actual operation state in an adjacent manner for each of the plurality of apparatuses.

In other words, the program according to the invention is a program for causing a computer capable of communicating with the control device included in the apparatus administration system according to any of the 1st to 11th configurations to function as: an information acquisition unit configured to acquire the operation schedule and the operation history from the control device; a date and time setting unit configured to specify a past date and time to set it as a set date and time; an estimation unit configured to estimate an operation state under schedule control at the set date and time based on the operation schedule for each of the plurality of apparatuses; an extraction unit configured to extract from the operation history an actual operation state at the set date and time for each of the plurality of apparatuses; and a display unit configured to display the operation state under schedule control and the actual operation state in an adjacent manner for each of the plurality of apparatuses.

It is preferable that the program according to the present invention is stored in a computer readable storage medium.

With the present invention, an operation state under schedule control and an actual operation state at a set date time are displayed in an adjacent manner for each apparatus. Thus, according to the present invention, it is possible for a user to easily compare operation states under schedule control and actual operation states in a set date and time, and accordingly to easily grasp the difference between operation states under schedule control and actual operation states in the set date and time.

### BRIEF DESCRIPTION OF DRAWINGS

Preferred embodiments of the present invention will now be described in further detail. Other features and advantages of the present invention will be more fully understood, taken in conjunction with the following detailed description and attached drawings where:

FIG. 1 is a block diagram illustrating a configuration of an apparatus administration system according to an embodiment;

FIG. 2 is a schematic planar view of an area in which a plurality of apparatuses and sensor devices are disposed;

FIG. 3 is a diagram illustrating an operation schedule used in the apparatus administration system according to the embodiment;

FIG. 4 is a diagram illustrating an operation history used in the apparatus administration system according to the embodiment;

FIG. 5 is a diagram illustrating location information used in the apparatus administration system according to the embodiment;

FIG. 6 is a diagram illustrating a display screen of a display device according to the embodiment;

FIG. 7 is a diagram illustrating a variation of a display screen of the display device according to the embodiment;

FIG. 8 is a diagram illustrating a sensor history used in the apparatus administration system according to the embodiment;

FIG. 9 is a diagram illustrating thresholds related to environment information used in the apparatus administration system according to the embodiment; and

FIG. 10 is a diagram illustrating a variation of an icon used in the display device according to the embodiment.

### BEST MODE FOR CARRYING OUT THE INVENTION

In the embodiment, an apparatus administration system for managing a plurality of apparatuses will be described. In the embodiment, “monitoring an operation state of an apparatus” and “controlling operation of the apparatus” are referred to as “managing” the apparatus. Therefore, management (administration) of the apparatuses indicates at least one of “the monitoring of the apparatus” and “the control of the apparatus”.

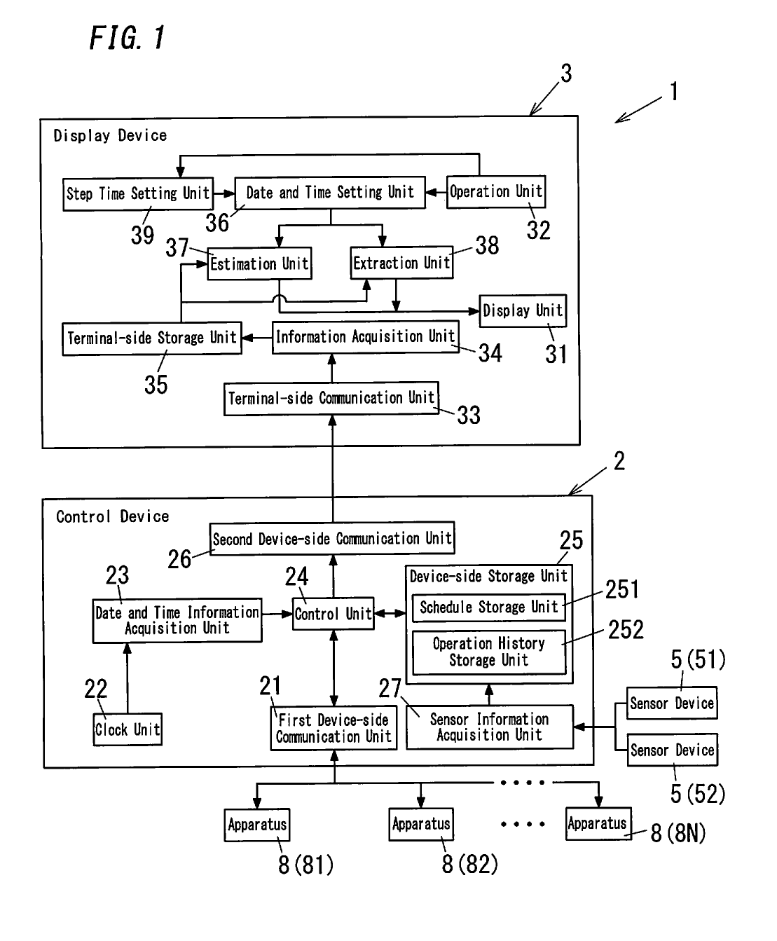

An apparatus administration system 1 according to the embodiment includes, as shown in FIG. 1, a control device 2 that controls operation of a plurality of apparatuses 8(81), 8(82), . . . , 8(8N) by communication, and a display device 3 that is communicable with the control device 2. The apparatuses 8 are disposed in a predetermined area 7.

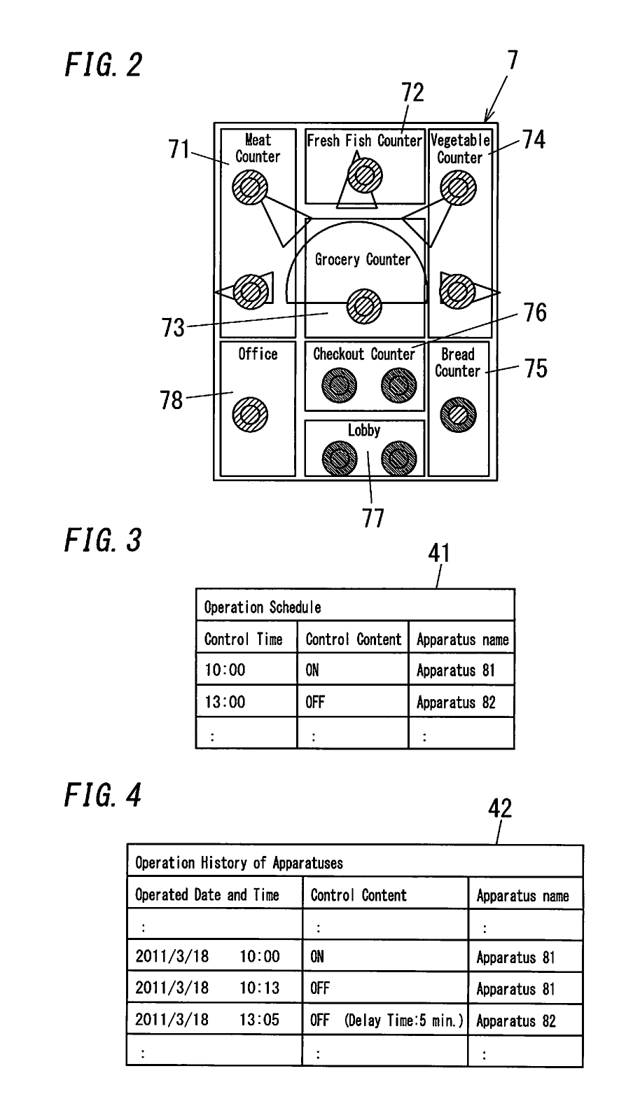

The area 7 where the apparatuses 8 are disposed is a food supermarket shown in FIG. 2 or the like. The area 7 shown in FIG. 2 includes a meat counter 71, a fresh fish counter 72, a grocery counter 73, a vegetable counter 74, a bread counter 75, a checkout counter 76, a lobby 77 and an office 78. Note that the area 7 where the apparatuses 8 are disposed is not limited to the above, and may be other places (e.g., private residence, office, etc.).

In the embodiment, the apparatus 8 is an apparatus for controlling a lighting environment in the area 7, an air-conditioning environment in the area 7, or the like. That is to say, the apparatus 8 is, for example, a lighting apparatus for controlling the brightness in the area 7, an air-conditioning apparatus for controlling the temperature in the area 7, a freezing machine for frozen foods or the like, a refrigerating machine, or the like. The plurality of apparatuses 81, 82, . . . , 8N may be a combination of different kinds (at least two of a lighting apparatus, an air-conditioning apparatus, a freezing machine, and a refrigerating machine, for example), or may be of the same kind (one of lighting apparatuses, air-conditioning apparatuses, freezing machines, and refrigerating machines, for example).

Next, the control device 2 will be described. The control device 2 has a computer on which a CPU (Central Processing Unit) and a memory are mounted as the main constituent elements. The control device 2 instructs operation of the apparatuses 8, and collects information related to the operation states of the respective apparatuses 8. The control device 2 includes, as shown in FIG. 1, a first device-side communication unit 21, a clock unit 22, a date and time information acquisition unit 23, a control unit 24, a device-side storage unit 25, and a second device-side communication unit 26. The control device 2 is installed in a different place from the area 7 where the apparatuses 8 are disposed.

The first device-side communication unit 21 is a communication interface for the control device 2 to communicate with each of the apparatuses 8. The communication between the control device 2 and each of the apparatuses 8 may be based on time division multiplex transmission, and may be wired communication such as Ethernet, or RS-232C, or wireless communication such as ZigBee.

The date and time information acquisition unit 23 acquires from the clock unit 22 date and time information related to the current date and time. The clock unit 22 is a real time clock (RTC) or the like, and clocks the current date and time. The current date and time that the clock unit 22 clocks is a combination of a date (year/month/date) and a time (hour/minute/second). Note that the clock unit 22 does not necessarily need to be included in the control device 2. The date and time information acquisition unit 23 may acquire date and time information from an external apparatus.

The control unit 24 controls each apparatus 8 in accordance with an operation schedule 41 stored in the device-side storage unit 25. The control unit 24 periodically refers to the date and time information acquired by the date and time information acquisition unit 23. When the current date and time indicated by the date and time information coincides with a control date and time included in the operation schedule 41, the control unit 24 outputs a control signal to a control-targeted apparatus 8. The control signal includes information related to a control content (ON or OFF) of the apparatus 8.

When a switch (not shown) for changing operation of an apparatus 8 is manipulated, the control unit 24 prioritizes the manipulation related to the switch over the operation schedule 41 to control the apparatus 8.

That is to say, the control unit 24 controls each apparatus 8 in accordance with the operation schedule 41, and, upon being conducted manipulation related to operation change (i.e., upon receiving a signal related to operation change), controls each apparatus 8 with priority given to the manipulation related to operation change over the operation schedule 41.

The control unit 24 has, in addition to the function of controlling the apparatuses 8 as the above mentioned manner, a function of periodically monitoring operation states of the apparatuses 8 and acquiring (information about) the operation states through the first device-side communication unit 21. The acquired operation states of the apparatuses 8 are stored in the device-side storage unit 25 with associated with the times when the operation states are acquired.

The device-side storage unit 25 includes a schedule storage unit 251 that stores the operation schedule 41 and an operation history storage unit 252 that stores a history of actual operation states of the apparatuses 8.

The schedule storage unit 251 stores an operation schedule 41 as shown in FIG. 3. In the operation schedule 41, control contents are associated with control dates and times for each of the apparatuses 8. That is to say, the operation schedule 41 associates sets of information about “time”, “name of apparatus 8”, and “control content” with each other. In a case where the operation schedule 41 includes the same control contents for each day as in an example shown in FIG. 3, the control date and time may include only a “control time (hour/minute/second)”.

The operation history storage unit 252 stores, as an operation history 42, past operation states with associating with operated dates and times for each of the apparatuses 8. As described above, operation states of the apparatuses 8 are monitored periodically by the control unit 24. Note that, the operation history storage unit 252 may be configured to store all the operation states at each dates and times for each of the apparatuses 8, or may be configured to store the information at the time when the operation state is changed for each of the apparatuses 8. That is to say, the operation history storage unit 252 is configured to store information that “apparatus 8 of which operation state has changed”, “date and time at which the operation state has changed”, and “operation state after the change” can be obtained therefrom.

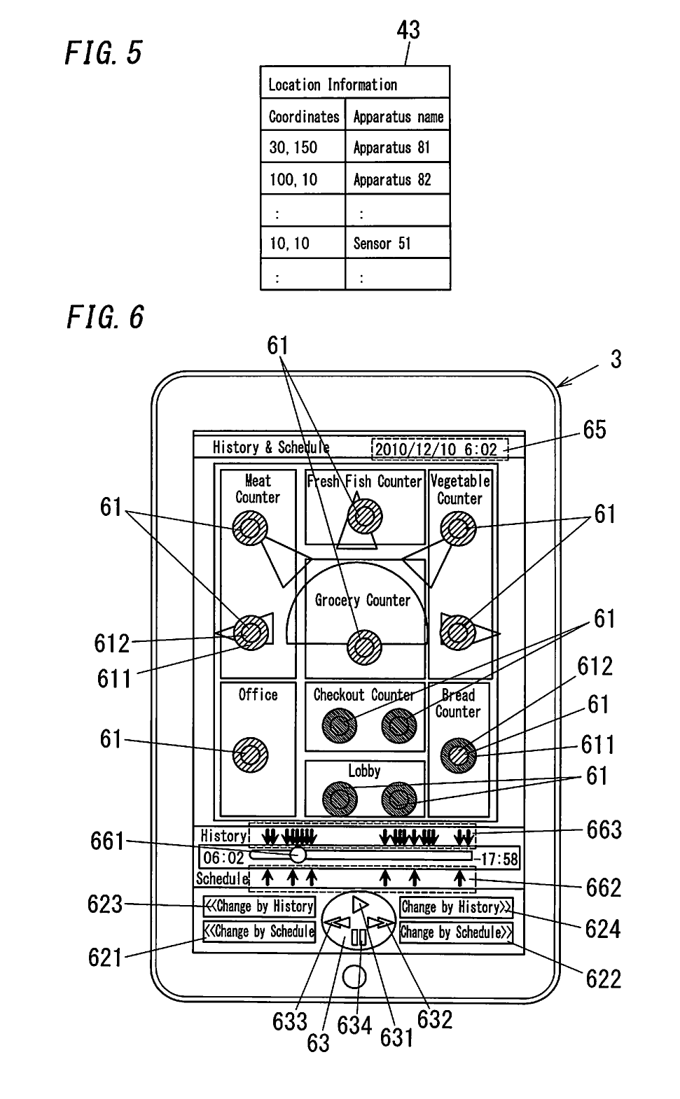

The device-side storage unit 25 stores map information and location information 43 shown in FIG. 5. The map information is information about a map of the area 7 in which the apparatuses 8 are disposed. The location information 43 is information indicating locations of the apparatuses 8.

The second device-side communication unit 26 is a communication interface for the control device 2 to communicate with the display device 3, and exchanges information with the display device 3. Specifically, the second device-side communication unit 26 transmits information that is stored in the device-side storage unit 25. The communication between the control device 2 and the display device 3 may be IP communication using a wired LAN (Local Area Network), a wireless LAN or the like, or communication using a dedicated line such that the display device 3 is directly installed to the control device 2.

Next, the display device 3 will be described. The display device 3 is a portable terminal such as a tablet personal computer, and a CPU and a memory are mounted thereon. The display device 3 includes a display unit 31, an operation unit 32, a terminal-side communication unit 33, an information acquisition unit 34, a terminal-side storage unit 35, a date and time setting unit 36, an estimation unit 37, and an extraction unit 38.

The display unit 31 is, for example, a liquid crystal display, an organic EL (Electro-Luminescence) display, or the like, and displays various kinds of information. Detailed configuration of the display unit 31 will be described later.

The operation unit 32 is activated when a user inputs information to the display device 3. Operation information is input to the operation unit 32 through a touch panel. Examples of the operation information includes operation information related to date and time setting such as information about “set date and time (designated date and time)”, information about “next change point in operation history or last(previous) change point in operation history”, information about “next point in schedule control or last(previous) point in schedule control”, and the like.

The terminal-side communication unit 33 is a communication interface for communication between the control device 2 and the display device 3, and exchanges information with the control device 2. Specifically, the terminal-side communication unit 33 receives information to be acquired by the information acquisition unit 34 from the control device 2 by communication.

The information acquisition unit 34 acquires from the control device 2 the operation schedule 41, the operation history 42, the map information and the location information 43. The information acquisition unit 34 may be configured to read in needed information from the display device 2 as needed, or may be configured to read in all the information from the display device 2 at once. That is to say, the information acquisition unit 34 may be configured to obtain needed information from the display device 2 through the terminal-side communication unit 33 as needed. Alternatively, the information acquisition unit 34 may be configured to obtain all the information from the control device 2 in a lump.

The terminal-side storage unit 35 stores information acquired by the information acquisition unit 34. That is to say, the terminal-side storage unit 35 stores the operation schedule 41, the operation history 42, the map information and the location information 43.

The date and time setting unit 36 sets, when operation information related to date and time setting is input to the operation unit 32, the date and time indicated by the operation information as the set date and time. That is to say, the date and time setting unit 36 is configured to set a “set date and time” based on input through the operation unit 32.

The estimation unit 37 estimates, for each of the plurality of apparatuses 8, an operation state under schedule control at the set date and time based on the operation schedule 41. Specifically, the estimation unit 37 extracts a control content which is included in the operation schedule 41 in the terminal-side storage unit 35 and associated with the set date and time set by the date and time setting unit 36, and then estimates an operation state under schedule control (control in accordance with the operation schedule 41), for each apparatus 8. The estimation unit 37 then outputs the estimated “operation states under schedule control” to the display unit 31. That is to say, the estimation unit 37 estimates an operation state in accordance with the operation schedule 41 at the set date and time and outputs it as an “operation state under schedule control”, for each of the plurality of apparatuses 8.

The extraction unit 38 extracts from the operation history 42 an actual operation state at the set date and time set by the date and time setting unit 36, for each apparatus 8. Specifically, the extraction unit 38 extracts, for each apparatus 8, an actual operation state at the set date and time from the operation history 42 stored in the terminal-side storage unit 35 (alternatively, from the operation history 42 stored in the device-side storage unit 25 and acquired by the information acquired unit 34). The extraction unit 38 outputs the extracted “actual operation states” to the display unit 31. That is to say, the extraction unit 38 extracts an operation state at the set date and time from the operation history 42 and outputs it as an “actual operation state”, for each of the plurality of apparatuses 8.

The display unit 31 reads in the map information and the location information 43 which are stored in the terminal-side storage unit 35, in order to display the locations of the apparatuses 8 on the map by icons 61. The display unit 31 that has received various kinds of information displays, on a middle of the screen, the “operation state under schedule control” and the “actual operation state” at the set date and time in an adjacent manner by means of an icon 61 for each of the plurality of apparatuses 8, as shown in FIG. 6. That is to say, the display unit 31 displays the operation state under schedule control at the set date and time set by the date and time setting unit 36 (i.e., “operation state under schedule control” input from the estimation unit 37) and the actual operation state at the set date and time (“actual operation state” input from the extraction unit 38) in an adjacent manner for each apparatus 8. Each icon 61 includes a first display region 611 for showing the “operation state under schedule control” and a second display region 612 for showing the “actual operation state”. The first display region 611 and the second display region 612 are adjacent directly (contact) to each other. In the embodiment, the display unit 31 displays the icons 61 in a superimposed manner on a map on which locations of the apparatuses 8 are indicated. In each icon 61, outer frame region (first display region 611) represents the “operation state under schedule control”, and inner region (second display region 612) represents the “actual operation state” of the apparatus 8. A display form of the icon 61 differs depending on the operation state. In the embodiment, different colors are allocated to the operation states. For example, color of “green” is allocated to an operation state of OFF (i.e., deactivating the apparatus 8), and color of “red” is allocated to an operation state of ON (i.e., activating the apparatus 8). In the embodiment, the icon 61 has a shape of double circle, and “operation state under schedule control” is expressed by a color in a region between the outer circle and the inner circle (first display region 611), and “actual operation state” is expressed by a color in a region inside the inner circle (second display region 612).

When the set date and time is changed by the date and time setting unit 36, the display unit 31 receives information corresponding to the new set date and time, and then displays the “operation state under schedule control” and the “actual operation state” at the new set date and time in an adjacent manner by each icon 61.

Specifically, when a new set date and time is set by the date and time setting unit 31, the estimation unit 37 estimates operation states under schedule control at the new set date and time, and outputs the estimated “new operation states under schedule control”. Moreover, the extraction unit 38 extracts actual operation states at the new set date and time from the operation history 42, and outputs the “new actual operation states”. The display unit 31 then displays, by each icon 61, the “operation state under schedule control” and the “actual operation state” adjacently.

The display unit 31 displays on a lower region of the screen a timeline chart on which “control dates and times” included in the operation schedule 41 and “operated dates and times” included in the operation history 42 are shown. The control dates and times are represented by arrows (reference sign “662” in FIG. 6) shown below a slider 661. The operated dates and times are represented by arrows (reference sign “663” in FIG. 6) shown above the slider 661. That is to say, in the display unit 31, the time axis is expressed by the linear slider 661, and the control dates and times and the operated dates and times are displayed in chronological order through the slider 661. The display unit 31 displays a set date and time (reference sign “65” in FIG. 6) on an upper region of the screen

The date and time setting unit 36 sets a set date and time based on a date and time designated through the displayed timeline chart. That is to say, the date and time setting unit 36 sets, in response to input through the operation unit 32, a set date and time based on a date and time designated through the displayed timeline chart. In the example shown in FIG. 6, the date and time setting unit 36 sets a set date and time in response to manipulation (it is assumed that the device includes a touch panel) of the slider 661 by a user. In the embodiment, the left end of the slider 661 indicates 0:00 a.m. on a day (Dec. 10, 2010 in the example of FIG. 6), and the right end of the slider 661 indicates 0:00 a.m. on the next day. The date and time setting unit 36 sets, as the set date and time, a date and time indicated by a position of a tub 664. The control dates and times as well as the operated dates and times are represented by arrows 662, 663, and therefore a user can determine a set date and time using the arrows 662, 663 as a guide.

The date and time setting unit 36 is configured to specify a date and time to be set as a set date and time, with using a set of control dates and times included in the operation schedule 41 as an index. As shown in FIG. 6, a first icon 621 for allowing a user to select a control date and time before the current set date and time, and a second icon 622 for allowing a user to select a control date and time after the current set date and time, are displayed on a lower region of the screen. When a user flicks the first icon 621 “n1” times (n1=1, 2, . . . ), the date and time setting unit 36 sets a control date and time which is before and the “n1th”-closest to the current set date and time, as a new set date and time. For example, when a user flicks the first icon 621 one time, a control date and time just before the current set date and time is determined to be a new set date and time by the date and time setting unit 36. When a user flicks the first icon 621 two times, a control date and time which is before and the second-closest to the current set date and time is determined to be a new set date and time by the date and time setting unit 36. Moreover, when a user flicks the second icon 622 “n2” times (n2=1, 2, . . . ), the date and time setting unit 36 sets a control date and time which is after and the “n2th”-closest to the current set date and time, as a new set date and time. For example, when a user flicks the second icon 622 one time, a control date and time just after the current set date and time is determined to be a new set date and time by the date and time setting unit 36. When a user flicks the second icon 622 two times, a control date and time which is after and the second-closest to the current set date and time is determined to be a new set date and time by the date and time setting unit 36.

The date and time setting unit 36 also is configured to specify a date and time to be set as a set date and time, with using a set of operated dates and times included in the operation history 42 as an index. As shown in FIG. 6, a third icon 623 for allowing a user to select an operated date and time before the current set date and time, and a fourth icon 624 for allowing a user to select an operated date and time after the current set date and time, are displayed on a lower region of the screen. When a user flicks the third icon 623 “n3” times (n3=1, 2, . . . ), the date and time setting unit 36 sets an operated date and time which is before and the “n3th”-closest to the current set date and time, as a new set date and time. For example, when a user flicks the third icon 623 one time, an operated date and time just before the current set date and time is determined to be a new set date and time by the date and time setting unit 36. When a user flicks the third icon 623 two times, an operated date and time which is before and the second-closest to the current set date and time is determined to be a new set date and time by the date and time setting unit 36. Moreover, when a user flicks the fourth icon 624 “n4” times (n4=1, 2, . . . ), the date and time setting unit 36 sets an operated date and time which is after and the “n4th”-closest to the current set date and time, as a new set date and time. For example, when a user flicks the fourth icon 624 one time, an operated date and time just after the current set date and time is determined to be a new set date and time by the date and time setting unit 36. When a user flicks the fourth icon 624 two times, an operated date and time which is after and the second-closest to the current set date and time is determined to be a new set date and time by the date and time setting unit 36.

As shown in FIG. 1, the display device 3 further includes a step time setting unit 39 for determining a step time which is to be added to or subtracted from the set date and time.

The step time setting unit 39 determines a step time in response to manipulation on the touch panel of the operation unit 32. The “step time” is a time length to be added to or subtracted from a set date and time which has been set by the date and time setting unit 36.

The date and time setting unit 36 has a function of setting a date and time which is obtained by adding to or subtracting from the set date and time the step time set by the step time setting unit 39, as a new set date and time. For example, the date and time setting unit 36 may be configured to update the “set date and time” per a predetermined time. For example, the date and time setting unit 36 replaces the current set date and time with a date and time obtained by adding to or subtracting from the set date and time the step time set by the step time setting unit 39, per a predetermined time (e.g., every second). For example, it will be assumed that the setting date and time is set at “10:00” and the step time is set at “2 minutes”. In this case, one second after displaying the operation states at the set date and time of “10:00” on the display unit 31, the date and time setting unit 36 sets, as a new set date and time, a date and time of “10:02” which is obtained by adding the step time of “2 minutes” to the set date and time of “10:00”. Then, the display unit 31 displays operation states at the new set date and time “10:02”. One second after that, the date and time setting unit 36 sets, as a new set date and time, a date and time of “10:04” which is obtained by adding the step time of “2 minutes” to the set date and time of “10:02”. Then, the display unit 31 displays operation states at the new set date and time “10:04”. The date and time setting unit 36 and the display unit 31 repeat the above behavior.

As shown in FIG. 6, an icon 63 shaped like a button is displayed on a lower region of the screen. The icon 63 includes a “play button 631”, a “fast-forward button 632”, a “rewind button 633” and a “pause button 634”. The step time setting unit 39 may be configured to change (the length of) the step time in response to manipulation to the icon 63 by a user. For example, when the play button 631 is tapped, the step time setting unit 39 sets the length of the step time to be a default value (e.g., one minute) prestored in the step time setting unit 39. For example, when the play button 631 is tapped, the step time setting unit 39 sets the length of the step time to be a value (e.g., “6 minutes”) which is obtained by dividing an interval (e.g., “60 minutes”) between the current set date and time and a next control date and time by a predetermined value (e.g., “10”). For example, when the fast-forward button 632 is tapped, the step time setting unit 39 lengthens (e.g., doubles) the step time. For example, when the rewind button 633 is tapped, the step time setting unit 39 sets the length of the step time to be a “negative” value (in this case, the date and time setting unit 36 sets, as a new set date and time, a date and time obtained by subtracting the magnitude of the step time from the current set date and time). For example, when the pause button 634 is tapped, the step time setting unit 39 sets the length of the step time to be (temporarily) “0”. The step time setting unit 39 may be configured to determine the step time in a manner of shortening the step time with respect to a period in which a large number of control dates and times etc. is included, and elongating the step time with respect to a period in which a small number of control dates and times etc. is included, as described detail later. With such the configuration, the display unit 31 can display the past operation states without causing a skip of information.

The step time setting unit 39 has a function of shortening the step time to a period which includes a large number of schedule control, and elongating the step time to a period which includes a small number of schedule control, in addition to the function of setting a length of the step time in response to manipulation on the operation unit 32. Specifically, the step time setting unit 39 calculates intervals between control dates and times, and allocates a shorter step time to the period having shorter intervals between the control dates and times and a longer step time to the period having longer intervals between the control dates and times. The step time is so determined that any schedule control is not skipped.

The step time setting unit 39 may be configured to determine the step time in a manner of shortening the step time to a period which includes a large number of operated date and time and elongating the step time to a period which includes a small number of operated date and time, instead of using the schedule control. The step time is so determined that any actual operation state is not skipped.

In case where a touch operation on a touch panel screen (display screen) by a user is a flick operation, it may be possible to differentiate a change content of a set date and time depending on the direction of the flick operation. For example, it may be assumed such a case that operation states at a date and time one minute after the current set date and time is displayed in response to a right flick. In this case, when the date and time setting unit 36 receives, in response to a right flick by a user, information indicating the right flick, the date and time setting unit 36 sets, as a new set date and time, a date and time obtained by adding a step time of “one minute” to the current set date and time. Operation states (“operation states under schedule control” and “actual operation states”) at the new set date and time (i.e., one minute later) are displayed on the middle region of the screen. In this case, when the date and time setting unit 36 receives, in response to a left flick, information indicating the left flick, the date and time setting unit 36 sets, as a new set date and time, a date and time obtained by subtracting the step time of “one minute” from the current set date and time. Operation states at the new set date and time (one minute earlier) are displayed on the middle region of the screen. As similar, operation states at a date and time one day before the current set date and time may be displayed in response to a down flick, and operation states at a date and time one day after the current set date and time may be displayed in response to an up flick. With this configuration, the step time setting unit 39 can change the length of the step time for meeting needs of a user.

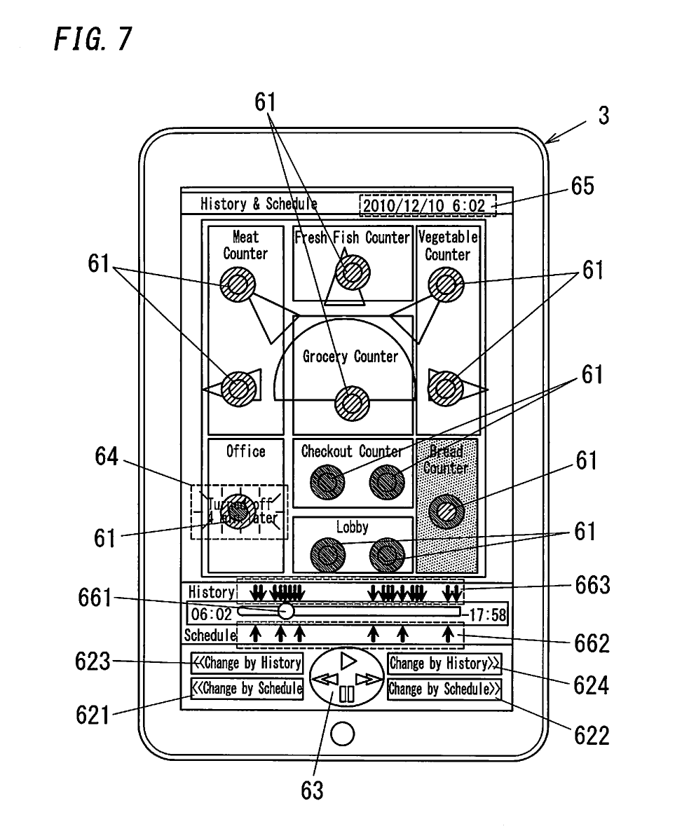

In a case where the schedule control includes a delay time (a delay time is preset), the display unit 31 displays information about elapsed time regarding the delay time together with the “operation state under schedule control”. For example, in a case of a “delay-off control” which reserves to turn off (e.g., at 6:01) and actually turns off the apparatus 8 at five minutes later (e.g., 6:06) by the schedule control, as shown in a region of “Office” in FIG. 7, the display unit 31 displays information about delay time 64 together with the icon 61. With this configuration, it is possible for a user to understand whether the apparatus 8 was under schedule control or the apparatus 8 was forgotten to be turned off (or lighten on purpose).

As shown in FIG. 1, the apparatus administration system 1 includes sensor devices (two in the illustrated example) 5(51), 5(52) configured to measure individually the environmental condition in the area 7 (see FIG. 2). Moreover, the control device 2 includes a sensor information acquisition unit 27 that acquires sensor information from each sensor device 5. Examples of the environmental condition in the area 7 in the embodiment include the brightness in the area 7 and the temperature in the area 7. Examples of the brightness in the area 7 include the illuminance and the luminance in the area 7.

Each of the sensor devices 5 may be a brightness sensor measuring the brightness in the area 7, a temperature sensor measuring the temperature in the area 7, or the like. The sensor devices 5 are disposed in the area 7. The brightness sensor may be an illuminance sensor, a luminance sensor, or the like. The sensor devices 51, 52 may be a combination of different kinds (at least two of a brightness sensor and a temperature sensor, for example), or may be of the same kind (one of brightness sensors and temperature sensors).

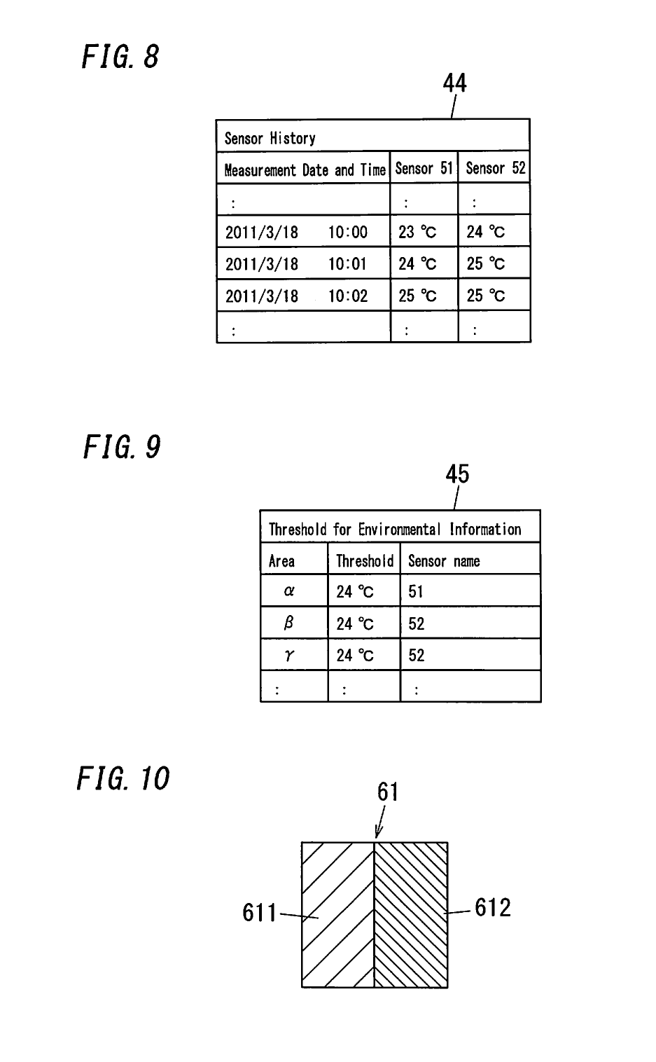

The sensor information acquisition unit 27 acquires sensor information from each sensor device 5. The sensor information is information related to a measurement result by the sensor device 5. Sets of the sensor information acquired by the sensor information acquisition unit 27 are stored sequentially in the operation history storage unit 252. That is to say, the operation history storage unit 252 stores a sensor history 44 as a history of the sensor information, as shown in FIG. 8.

In the display device 3 shown in FIG. 1, the information acquisition unit 34 acquires the sensor history 44 from the control device 2, and the terminal-side storage unit 35 stores the sensor history 44 acquired by the information acquisition unit 34.

The display unit 31 displays the environmental condition in the area 7 at the set date and time in a manner of changing a visual effect of the area 7 on the map depending on the environmental condition included in the sensor information at the set date and time (the date and time displayed on the display unit 31 currently). It will be described a case where the sensor devices 5 are temperature sensors. In the example shown in FIG. 7, the display unit 31 displays the “bakery counter” on the map in an unconventional form (different color from a normal condition, for example) for indicating a condition of “too cold”. If the obtained sensor information at the set date and time indicates a condition that the temperature is lower than a threshold, the display unit 31 displays a corresponding sub-area in an unconventional form for indicating a condition of “too cold”. For example, the display unit 31 colors this corresponding sub-area in blue for indicating the condition of “too cold”. If the obtained sensor information indicates a condition that the temperature is higher than a threshold, the display unit 31 displays a corresponding sub-area in an unconventional form for indicating a condition of “too hot”. For example, the display unit 31 colors this corresponding sub-area in orange for indicating the condition of “too hot”. The threshold indicates a threshold 45 related to environmental information as shown in FIG. 9, and is stored in the device-side storage unit 25 and the terminal-side storage unit 35.

Note that programs for the control device 2 to execute various functions are stored in the device-side storage unit 25 of the control device 2. That is to say, programs for causing the control device (computer) 2 to function as the first device-side communication unit 21, the clock unit 22, the date and time information acquisition unit 23, the control unit 24, the device-side storage unit 25, the second device-side communication unit 26, and the sensor information acquisition unit 27 are stored in the device-side storage unit 25.

The above programs are pre-stored in the device-side storage unit 25 before shipping the control device 2. However, the above programs may be loaded into the device-side storage unit 25 after shipment of the control device 2. In a case where the above programs are loaded into the control device 2 after shipment, examples of method for loading the above programs to the control device 2 include a method to use a computer-readable recording medium in which the above programs are recorded. The recording medium is a memory card, a CD-ROM, a DVD-ROM, or the like. For using a recording medium, the control device 2 is required to be provided with at least a drive device (not shown) to read data recoded in the recording medium. The examples also include a method to download the above programs from a server through a network. For downloading the above programs through the network, the control device 2 is required to have at least a communication function (not shown) for communicating with the server through the network.

Moreover, programs for the mobile terminal 3 to execute various functions are stored in the terminal-side storage unit 35 of the mobile terminal 3. That is to say, programs for causing the display device (computer) 3 to function as the display unit 31, the operation unit 32, the terminal-side communication unit 33, the information acquisition unit 34, the terminal-side storage unit 35, the date and time setting unit 36, the estimation unit 37, and the extraction unit 38 are stored in the terminal-side storage unit 35.

The above programs are pre-stored in the terminal-side storage unit 35 before shipping the mobile terminal 3. However, the above programs may be loaded into the terminal-side storage unit 35 after shipment of the mobile terminal 3. In a case where the above programs are loaded into the mobile terminal 3 after shipment, examples of method for loading the above programs to the mobile terminal 3 include a method to use a computer-readable recording medium in which the above programs are recorded. The recording medium is a memory card, a CD-ROM, a DVD-ROM, or the like. For using a recording medium, the mobile terminal 3 is required to be provided with at least a drive device (not shown) to read data recorded in the recording medium. The examples also include a method to download the above programs through a server using a network. For downloading the above programs through the network, the mobile terminal 3 is required to have at least a communication function (not shown) for communicating with the server through the network.

The icon 61 is not limited to the example shown in the above embodiment, as long as it can display “operation state under schedule control” and “actual operation state” in an adjacent manner. For example, the shape of the icon 61 is not limited to a double circle, and may be a shape a square divided in two (left and right) regions (see FIG. 10). In this case, it is possible that “operation state under schedule control” is expressed by the color of the left region (first display region 611) of the icon 61, and “actual operation state” is expressed by the color of the right region (second display region 612) of the icon 61.

As described above, in the apparatus administration system 1 of the embodiment, the display device 3 displays the operation state under schedule control (operation state estimated through the operation schedule 41) and the actual operation state at the set date and time in an adjacent manner, for each apparatus 8. Thus, according to the embodiment, it is possible for a user to easily compare operation states under schedule control and actual operation states in a set date and time, and accordingly to easily grasp the difference between “operation states under schedule control” and “actual operation states” in a set date and time. As a result, it is possible to make ease an analysis for proposing an energy-saving method.

With the apparatus administration system 1 according to the embodiment, the operation state under schedule control and the actual operation state are displayed in an adjacent manner by means of an icon 61. Accordingly, the embodiment has an advantage of easily perform an analysis on-site, in comparison with a case where the operation state under schedule control and the actual operation state are represented by characters (text).

With the embodiment, the display device 3 displays the icons 61 on locations of the respective apparatuses 8 on the map. Accordingly, it is possible to more easily perform the analysis on-site.

According to the embodiment, due to each apparatus 8 being located in a predetermined area 7 and the display device 3 being formed of a portable mobile terminal, a user can grasp the operating states of the apparatuses 8 in the area 7 while confirming the on-site situation. Thus, the operation schedule 41, for example, can be easily adjusted.

With the embodiment, the date and time setting unit 36 of the display device 3 is configured to set a set date and time based on a date and time designated through a timeline chart on which at least one set of dates and times regarding the control date and time or the operated date and time is shown. Accordingly, it is easy to designate a date and time proximate to an actually controlled date and time (a control date and time or an operated date and time) for setting a set date and time.

With the apparatus administration system 1 according to the embodiment, the date and time setting unit 36 specifies a date and time to be set as the set date and time, with using at least one set of dates and times regarding the control date and time or the operated date and time as an index. Accordingly, it is possible to designate an actually controlled date and time (control date and time or operated date and time) to be set as a set date and time.

According to the embodiment, since the date and time setting unit 36 of the display device 3 obtains a date and time by adding to or subtracting from the set date and time a step time to set it as a new set date and time, the display unit 31 can replay sequentially a plurality of actual operation states at the set dates and times.

With regard to this configuration, the display device 3 may shorten the step time with respect to a period which includes a large number of control dates and times and elongate the step time with respect to a period which includes a small number of control dates and times. With this configuration, since the period including a large number of schedule controls is played at slow speed and also the period including a small number of schedule controls is played at fast speed, it is possible to automatically emphasize the period which includes a lot of changes in operation states.

According to the embodiment, since (the length of) the step time can be set in accordance with manipulation on a touch panel of the operation unit 32, a user can instruct the length of the step time by a flick operation, for example, and can perform fast-forwarding operation and rewarding operation intuitively.

According to the embodiment, since the display unit 31 of the display device 3 changes the visual effect of the map depending on the environmental condition in the area 7, a user can perform the analysis for an energy-saving method with taking into consideration the environmental condition of the area 7.

Although the display device 3 is configured to acquire the map information and the location information 43 from the control device 2 in the embodiment, the map information and the location information 43 may, in a variation of the embodiment, be provided to the display device 3 from another method apart from the control device 2.

Although the present invention has been described with reference to certain preferred embodiments, numerous modifications and variations can be made by those skilled in the art without departing from the true spirit and scope of this invention, namely claims.

1. An apparatus administration system for managing a plurality of apparatuses, comprising:
a control device configured to control operation of each of the plurality of apparatuses by communication; and
a display device configured to communicate with the control device, wherein the control device includes:
a schedule storage unit configured to store an operation schedule in which control contents are associated with control dates and times for each of the plurality of apparatuses;
a control unit configured to control the plurality of apparatuses in accordance with the operation schedule and manipulation related to operation change; and
an operation history storage unit configured to store an operation history in which past operation states are associated with operated dates and times for each of the plurality of apparatuses, and
wherein the display device includes:
an information acquisition unit configured to acquire the operation schedule and the operation history from the control device;
a date and time setting unit configured to specify a past date and time to set as a set date and time;
an estimation unit configured to estimate an operation state under schedule control at the set date and time based on the operation schedule, for each of the plurality of apparatuses;
an extraction unit configured to extract from the operation history an actual operation state at the set date and time, for each of the plurality of apparatuses; and
a display unit configured to display the operation state under schedule control and the actual operation state in an adjacent manner, for each of the plurality of apparatuses.

2. The apparatus administration system according to claim 1,
wherein the display device is a portable mobile terminal, and
the plurality of apparatuses are located in a predetermined area.

3. The apparatus administration system according to claim 2, wherein the display unit is configured to display the operation state under schedule control and the actual operation state in an adjacent manner by means of an icon, for each of the plurality of apparatuses.

4. The apparatus administration system according to claim 3, wherein the display unit is configured to display, for each of the plurality of apparatuses, the icon in a superimposed manner on a map on which a location of the apparatus is indicated.

5. The apparatus administration system according to claim 1, wherein the display unit is configured, in a case where the schedule control includes a delay time, to display information about elapsed time regarding the delay time together with the operation state under schedule control.

6. The apparatus administration system according to claim 1,
wherein the display unit is configured to display a timeline chart on which at least one set of dates and times regarding the control date and time or the operated date and time is shown, and
the date and time setting unit is configured to set the set date and time in response to a date and time designated through the displayed timeline chart.

7. The apparatus administration system according to claim 1, wherein the date and time setting unit is configured to specify a date and time to be set as the set date and time with using at least one set of dates and times regarding the control date and time or the operated date and time as an index.

8. The apparatus administration system according to claim 1,
wherein the display device includes a step time setting unit configured to determine a step time to be added to or subtracted from the set date and time, and
the date and time setting unit is configured to set, a date and time obtained by adding to or subtracting from the set date and time the step time determined by the step time setting unit, as a new set date and time.

9. The apparatus administration system according to claim 8, wherein the step time setting unit is configured: to shorten the step time with respect to a period which includes a large number of control dates and times; and to elongate the step time with respect to a period which includes a small number of control dates and times.

10. The apparatus administration system according to claim 8,
wherein the display device includes an operation unit configured to enable to set a length of the step time through a touch panel, and
the step time setting unit is configured to determine the length of the step time in response to manipulation to the operation unit.

11. The apparatus administration system according to claim 4, further comprising a sensor device configured to measure an environmental condition in the area,
wherein the display unit is configured to change a visual effect of the map depending on the environmental condition measured through the sensor device.

12. A display device, capable of communicating with a control device that controls operation of a plurality of apparatuses by communication in accordance with an operation schedule in which control contents are associated with control dates and times and manipulation related to operation change and also that stores an operation history in which past operation states are associated with operated dates and times for each of the plurality of apparatuses, the display device comprising:
an information acquisition unit configured to acquire the operation schedule and the operation history from the control device;
a date and time setting unit configured to specify a past date and time to set as a set date and time;
an estimation unit configured to estimate an operation state under schedule control at the set date and time based on the operation schedule, for each of the plurality of apparatuses;
an extraction unit configured to extract from the operation history an actual operation state at the set date and time, for each of the plurality of apparatuses; and
a display unit configured to display the operation state under schedule control and the actual operation state in an adjacent manner, for each of the plurality of apparatuses.

13. A program for causing a computer capable of communicating with a control device that controls operation of a plurality of apparatuses by communication in accordance with an operation schedule in which control contents are associated with control dates and times and manipulation related to operation change and also that stores an operation history in which past operation states are associated with operated dates and times for each of the plurality of apparatuses to function as:
an information acquisition unit configured to acquire the operation schedule and the operation history from the control device;
a date and time setting unit configured to specify a past date and time to set as a set date and time;
an estimation unit configured to estimate an operation state under schedule control at the set date and time based on the operation schedule, for each of the plurality of apparatuses;
an extraction unit configured to extract from the operation history an actual operation state at the set date and time, for each of the plurality of apparatuses; and
a display unit configured to display the operation state under schedule control and the actual operation state in an adjacent manner, for each of the plurality of apparatuses.
